(19) United States
(12) Patent Application Publication
(10) Pub. No.: US 2007/0181645 A1
(43) Pub. Date: Aug. 9, 2007

(54) WIRE BONDING METHOD AND APPARATUS

(76) Inventors: Wing Cheung James Ho, Hong Kong (CN); Hon Shing Eddie Law, Hong Kong (CN); Kam Hong Kenneth Lam, Hong Kong (CN)

Correspondence Address: OSTROLENK FABER GERB & SOFFEN, 1180 AVENUE OF THE AMERICAS, NEW YORK, NY, 100368403, US

(21) Appl. No.: 11/621,535

(22) Filed: Jan. 9, 2007

Related U.S. Application Data
(60) Provisional application No. 60/759,132, filed on Jan. 13, 2006.

(51) Int. Cl. A47J 36/02

(52) U.S. Cl. 228/101

(57) ABSTRACT

A wire bonding method and apparatus are provided for electronic components to enable PR processing and wire bonding to be carried out substantially concurrently. The apparatus comprises a bond head carrying a bonding tool for performing wire bonding and a rotary motor coupled to the bond head that is configured to change an angular orientation of the bonding tool relative to an electronic component to be bonded. There are first and second carriers for respectively mounting electronic components for wire bonding, and an optical system is arranged and configured to view bonding points on an electronic component mounted on the first carrier when the bonding tool is located over an electronic component mounted on the second carrier to perform wire bonding.

### CROSS REFERENCE TO RELATED APPLICATION

This application claims the benefit and priority of U.S. Provisional Application Ser. No. 60/759,132 filed on Jan. 13, 2006, and entitled WIRE BONDING METHOD AND APPARATUS, the disclosure of which is incorporated herein by reference.

### FIELD OF THE INVENTION

The invention relates to wire bonding apparatus, and in particular to wire bonding apparatus that make wire connections between electronic components after wire bonding points have been determined by visual inspection of the electronic components.

### BACKGROUND AND PRIOR ART

Wire bonding is used in the semiconductor packaging industry to make electrical connections between electronic components, such as a die and a substrate on which the die is attached, or between the die and another die. Such wire bonding apparatus are generally divided into two types: ball bonding apparatus in which a ball is formed at the end of a wire to be bonded, and wedge wire bonding apparatus in which a wire is deformed as it is bonded. Wedge wire bonding apparatus make use of a wedge-shaped bonding tool.

Ball bonding apparatus only require the bonding head to be movable in three axes along the X, Y and Z directions. For wedge wire bonding apparatus, however, the bonding head and the electronic component must also be orientable relative to each other by rotation about the Z direction. For example, if a wire is being bonded at two places, before the first bond is made, the wire bonding head and electronic component must be relatively oriented so that the wedge bonding tool is aligned with the intended location of the second bond, and then the bonding head is moved along X and Y axes towards the second bonding location after a first bond is made.

Therefore, pattern recognition (“PR”) is required to identify the bonding points as well as the relative orientations of the respective bonding points on the electronic components prior to commencement of wire bonding so that the wedge bonding tool can be oriented correctly at each of the bonding points. This may be referred to as PR alignment or more generally as PR processing.

PR processing is usually performed using an optical system comprising a CCD camera. Typically, the PR processing and wire bonding operations are sequentially carried out, such that PR processing is performed first, followed by wire bonding. In some applications, there may be many bonding points to be recognized or there may be only a few wires that need to be bonded, and the time taken for PR processing would be more significant relative to the time taken for wire bonding as compared to scenarios where the time required for wire bonding is longer. In such cases, wire bonding cannot be performed while PR processing has yet to be completed. As a result, there is a bottleneck created during the duration of PR processing and the units per hour (UPH) achievable by the whole wire bonding process is lowered. It would be beneficial to be able to conduct PR processing and wire bonding concurrently to improve UPH.

In prior art wire bonding systems, the electronic component, typically a substrate, is sometimes mounted onto a work-holder of a theta-table, which is in turn mounted onto a positioning table for positioning the work-holder on a horizontal XY plane, such as an XY table. The XY table positions the substrate on an XY plane, whereas the theta-table is used to change an angular orientation of the substrate relative to the wedge bonding tool. There are at least two work-holders, wherein PR processing may be performed on a substrate on one work-holder, while concurrently, wire bonding is performed on the other work-holder.

However, implementing multiple rotary work-holders with theta-tables and theta motors for concurrent PR processing and wire bonding operations have several problems. One problem is that the effective bonding area is limited due to the limited accuracy of theta motors. Moreover, when a bonding point moves further away from the center of the theta table, accuracy becomes more dependent on accurately determining an effective axis of rotation between bonding points although the only true rotation is about the center of the theta-table. This introduces further errors when determining the precise locations of the bonding points.

With a limited bonding area, more frequent loading and unloading of substrates may be necessary, so that idle time for the other processes increases and this adversely affects UPH directly. Furthermore, more frequent operator attention is required as the frequency of loading and unloading increases.

Another disadvantage is that hardware correction parameters are necessary for both the theta-table and the cameras for performing PR processing. Since there would need to be at least two theta-tables for performing concurrent PR processing and bonding, accuracy decreases if more than one camera is used for PR processing because each combination of camera and theta-table would have its own set of hardware correction parameters. The potential for error is magnified. Worse, it is difficult to enable the two theta motors to rotate identically and if the two theta motors do not rotate to identical target angles, this leads to higher PR alignment failure rates and lower UPH.

In the case of LED devices, variation in placement positions is common, especially for LED devices created using manual die-attach methods. When using theta-tables, due to limited accuracy, variation of placement of the LED devices may lead to failure in PR alignment. The failure rate is higher when using theta-tables because the discrepancies in the location of the LED between different theta-tables on which substrates are placed are amplified after rotating the work-holders for PR processing and then for bonding. The further a bonding position is from the center of the theta-table, the higher would be the error. It would be desirable to seek to avoid the above problems faced with theta-tables mounted on multiple carriers.

### SUMMARY OF THE INVENTION

It is thus an object of the invention to seek to provide a wire bonding method and apparatus to avoid at least some of the disadvantages of the aforesaid prior art to achieve higher bonding accuracy while being able to perform PR processing and wire bonding substantially concurrently.

According to a first aspect of the invention, there is provided a wire bonding apparatus for electronic components comprising: a bond head carrying a bonding tool for performing wire bonding; a rotary motor coupled to the bond head that is configured to change an angular orientation of the bonding tool relative to an electronic component to be bonded; first and second carriers for respectively mounting electronic components for wire bonding; and a first optical system that is arranged and configured to view bonding points on an electronic component mounted on the first carrier when the bonding tool is located over an electronic component mounted on the second carrier to perform wire bonding.

According to a second aspect of the invention, there is provided a method for wire bonding electronic components, comprising the steps of: mounting electronic components on respective first and second carriers; changing an angular orientation of a bonding tool of a bond head relative to an electronic component on the first carrier using a rotary motor coupled to the bond head; and then performing wire bonding on the electronic component mounted on the first carrier with the bonding tool when viewing bonding points on an electronic component mounted on a second carrier using a first optical system.

It will be convenient to hereinafter describe the invention in greater detail by reference to the accompanying drawings. The particularity of the drawings and the related description is not to be understood as superseding the generality of the broad identification of the invention as defined by the claims.

### BRIEF DESCRIPTION OF THE DRAWINGS

An example of an apparatus and method for wire bonding electronic components in accordance with the invention will now be described with reference to the accompanying drawings, in which:

FIG. 1 is a side view of a wire bonding machine according to the preferred embodiment of the invention;

FIG. 2 is a side view of the optical systems, bond head and carriers of the wire bonding machine;

FIG. 3 is a plan view of the components illustrated in FIG. 2; and

FIG. 4 illustrates a sequence of operations using dual carriers mounted on a single positioning table.

### DETAILED DESCRIPTION OF THE PREFERRED EMBODIMENTS OF THE INVENTION

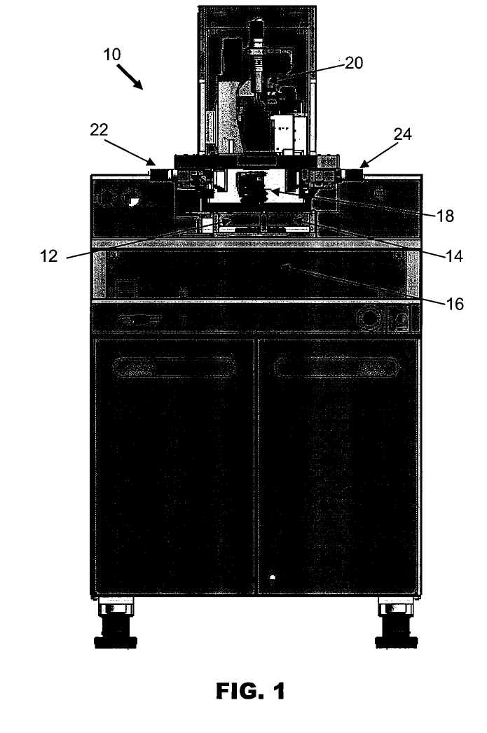

FIG. 1 is a side view of a wire bonding machine 10 according to the preferred embodiment of the invention. It generally comprises dual carriers, consisting of a left carrier 12 and a right carrier 14, a positioning table such as an XY table for controlling the positions of the dual carriers 12, 14, and a bond head 18 for performing wire bonding. The dual carriers 12, 14 are mounted on the XY table 16.

There are also a first optical system such as a left-side optical system 22, a second optical system such as a right-side optical system 24, and third optical system such as a central optical system 20. The optical systems 20, 22, 24 preferably have in-built auto-focus capability and adjustable magnification. The central optical system 20 is generally used for viewing bonding points before bonding and for monitoring the quality of bonded wires, whereas the left-side optical system 22 and right-side optical system 24 are arranged and configured to view bonding points on an electronic component for PR processing. The central optical system 20 can also be used as a back-up PR processing device if necessary, such as when the PR alignment of bonding points have to be re-done when PR alignment on a side optical system 22, 24 fails, or if the side optical systems 22, 24 are defective.

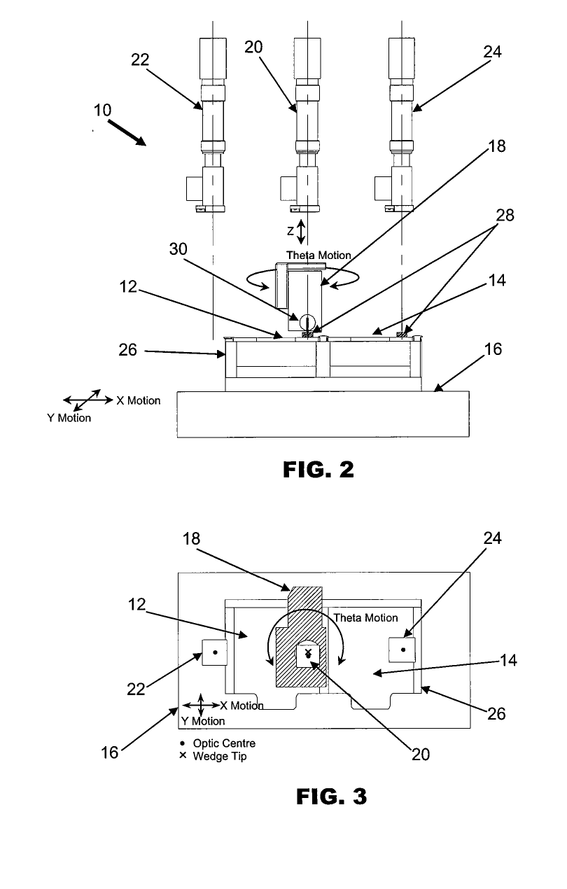

FIG. 2 is a side view of the optical systems 20, 22, 24, bond head 18 and carriers 12, 14 of the wire bonding machine 10. The left carrier 12 and right carrier 14 are both mounted on an XY table 16. Each carrier 12, 14 has a work-holder 26 for mounting one or more electronic components in the form of substrates 28, for example, one or more light-emitting devices (LEDs) or chip-on-board (COB) devices. The bond head 18 carries a bonding tool comprising a transducer 30 to perform wire bonding on each substrate 28. Furthermore, the bond head 18 is movable upwards and downwards vertically along a Z axis. A rotary motor such as a theta motor is coupled to the bond head 18, and it is configured to rotate and change the angular orientation of the transducer 30 relative to the substrate 28 in a theta direction about the Z axis. The rotation of the bond head 18 allows the wedge bonding tool to be oriented relative to the substrate 28 during the wire bonding process.

Therefore, at least two carriers can be combined in a single wire bonding system. While bonding is being performed on one or more carriers, PR processing may be performed on the substrates on the other carriers.

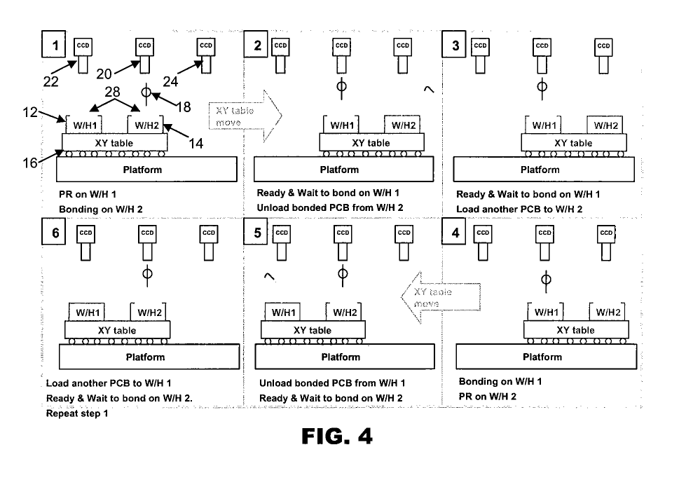

FIG. 3 is a plan view of the components illustrated in FIG. 2. The XY table 16 is movable on an XY plane and acts as a driver to reciprocate the carriers 12, 14 to a position under to the bond head 18 for wire bonding, and to positions under the left-side and right-side optical systems 22, 24 for PR processing. Preferably, a single XY table 16 is used for mounting both carriers 12, 14 for moving them at the same time. The central optical system 20 is positioned generally over the substrate to monitor the wire bonding quality of bonded wires on the same electronic component that is located for wire bonding. The bond head 18 is adapted for Z motion as well as theta motion to orientate its wire bonding tool. It is preferably collinearly located in between the left-side and right-side optical systems 22, 24. Making the bond head 18 rotatable to orientate the transducer 30 relative to the substrates placed on the carriers 12, 14 avoids the problem of having separate theta-tables and theta motors for orienting the transducer 30 relative to each substrate.

FIG. 4 illustrates a sequence of operations using dual carriers 12, 14 mounted on a positioning table in the form of an XY table 16. A substrate 28 is mounted on each of the carriers 12, 14. The XY table 16 first moves to position the left carrier 12 under the left-side optical system 22 for PR processing of the substrate 28 mounted on the left carrier 12, and the right carrier 14 under the bond head 18 for performing wire bonding on the substrate 28 mounted on the right carrier 14. It is assumed that PR processing has already been performed on the substrate 28 on the right carrier 14 so that the bonding tool may be correctly positioned and angularly oriented according to bonding points on the substrate 28 to perform wire bonding. Since the left-side optical system 22 is arranged and configured to view bonding points on a substrate 28 mounted on the left carrier when the transducer 30 is located over a substrate 28 mounted on the right carrier 14 for wire bonding, wire bonding is carried out concurrently on the substrate 28 held on the right carrier 14 when PR processing is carried out on the substrate 28 held on the left carrier 12.

After PR processing and wire bonding respectively have been completed on these two substrates 28, the XY table 16 is moved to the right wherein the left carrier 12 is then positioned under the bond head 18 for wire bonding while the right carrier 14 is positioned under the right-side optical system 24. The substrate 28 on the right carrier 14, which has already been wire bonded, is removed. A new substrate is placed onto the right carrier 14 so that PR processing may be performed on it.

Thus, wire bonding can be carried out on the substrate 28 on the left carrier 12, when PR processing is carried out on the substrate 28 on the right carrier 14. After wire bonding and PR processing respectively have been carried out, the XY table 16 is moved to the left so that the left carrier 12 is now positioned under the left-side optical system 22 and the right carrier 14 is positioned under the bond head 18 for wire bonding. The wire-bonded substrate 28 on the left carrier 12 is then offloaded, and a new unbonded substrate 28 is placed on the left carrier 12 for PR processing. The same general steps are undertaken for subsequent substrates 28 to be wire-bonded.

It would be appreciated that the wire bonding apparatus according to the preferred embodiments of the invention allow non-UPH productive PR operations to be performed in parallel with the UPH productive wire bonding operations. In this way, idle time for the bonding operations can be reduced and the UPH of the apparatus can be greatly increased compared to a similarly-arranged system with only one carrier. The UPH increase is especially prominent in applications which involve significant PR processing time as compared to wire bonding time.

In the preferred embodiment of the invention, since there is basically only one theta motor on the bond head 18 for orienting the bond head 18 with respect to the substrate 28, there is little impact on bonding and alignment accuracy due to the increase in the number of carriers. That is because unlike with carriers mounted with theta-tables for creating relative rotation between the bond head 18 and the substrate 28, error from the theta rotation is not introduced by the distance between the bonding area and the center of rotation of a theta motor. In theory, the bonding area can thereby be effectively unlimited.

Consequently, any variation in the placement of LED devices on a carrier, especially those created from manual die attachment, is not amplified by differences in the degree of rotation of different theta-tables. The success rate of PR alignment is not affected as long as the variation of the LED location is within an acceptable search range of the system. Another advantage is that when one of the carriers is defective or disabled, the apparatus is still capable of performing traditional sequential bonding operations on a single carrier.

The invention described herein is susceptible to variations, modifications and/or addition other than those specifically described and it is to be understood that the invention includes all such variations, modifications and/or additions which fall within the spirit and scope of the above description.

1. Wire bonding apparatus for electronic components comprising:
a bond head carrying a bonding tool for performing wire bonding;
a rotary motor coupled to the bond head that is configured to change an angular orientation of the bonding tool relative to an electronic component to be bonded;
first and second carriers for respectively mounting electronic components for wire bonding; and
a first optical system that is arranged and configured to view bonding points on an electronic component mounted on the first carrier when the bonding tool is located over an electronic component mounted on the second carrier to perform wire bonding.

2. Wire bonding apparatus as claimed in claim 1, further comprising a single positioning table on which both the first and second carriers are mounted for moving both carriers at the same time relative to the bond head and first optical system.

3. Wire bonding apparatus as claimed in claim 1, further comprising a second optical system that is arranged and configured to view bonding points on an electronic component mounted on the second carrier when the bonding tool is located over an electronic component mounted on the first carrier to perform wire bonding.

4. Wire bonding apparatus as claimed in claim 3, wherein the bond head is substantially collinearly located in between the first and second optical systems.

5. Wire bonding apparatus as claimed in claim 3, further comprising drivers to reciprocate the first and second carriers for movement between positions under the first or second optical system and a position under the bonding tool for performing wire bonding.

6. Wire bonding apparatus as claimed in claim 1, further comprising a third optical system located generally over the bond head and arranged and configured to view the same electronic component as that which is located for wire bonding by the bonding tool.

7. Method for wire bonding electronic components, comprising the steps of:
mounting electronic components on respective first and second carriers;
changing an angular orientation of a bonding tool of a bond head relative to an electronic component on the first carrier using a rotary motor coupled to the bond head; and then
performing wire bonding on the electronic component mounted on the first carrier with the bonding tool when viewing bonding points on an electronic component mounted on a second carrier using a first optical system.

8. Method for wire bonding electronic components as claimed in claim 7, further comprising the step of viewing bonding points on the electronic component after mounting it and before changing the angular orientation of the bonding tool according to the positions of the bonding points on the electronic component to perform wire bonding.

9. Method for wire bonding electronic components as claimed in claim 7, further comprising the steps of:
moving the first carrier away from the bonding tool and removing the bonded electronic component from the first carrier; and
moving the electronic component mounted on the second carrier under the bonding tool for wire bonding.

10. Method for wire bonding electronic components as claimed in claim 9, further comprising the step of performing wire bonding on the electronic component on the second carrier when viewing bonding points on an unbonded electronic component mounted on the first carrier.

11. Method for wire bonding electronic components as claimed in claim 10, wherein the viewing of bonding points on the unbonded electronic component is conducted using a second optical system.

12. Method for wire bonding electronic components as claimed in claim 11, wherein the bond head is substantially collinearly located in between the first and second optical systems.

13. Method for wire bonding electronic components as claimed in claim 11, including a third optical system located generally over the bond head and arranged and configured to view the same electronic component as that which is located for wire bonding by the bonding tool.

14. Method for wire bonding electronic components as claimed in claim 10, further comprising the steps of:
moving the second carrier away from the bonding tool and removing the bonded electronic component from the second carrier; and
moving the electronic component mounted on the first carrier under the bonding tool for wire bonding.

15. Method for wire bonding electronic components as claimed in claim 7, wherein both the first and second carriers are mounted on a single positioning table for moving both carriers at the same time relative to the bond head and first optical system.
